(19) United States
(12) Patent Application Publication
(10) Pub. No.: US 2026/0059410 A1
(43) Pub. Date: Feb. 26, 2026

(54) NETWORK SLICE HANDOVER IN WIRELESS COMMUNICATION NETWORKS

(71) Applicant: T-MOBILE INNOVATIONS LLC, Overland Park, KS (US)

(72) Inventor: Sanjay Laxman Kharate, Sammamish, WA (US)

(21) Appl. No.: 18/812,427

(22) Filed: Aug. 22, 2024

(51) Int. Cl. H04W 36/14; H04L 47/80; H04W 28/16

(52) U.S. Cl. CPC H04W 36/14; H04L 47/805; H04W 28/16

(57) ABSTRACT

Various embodiments include a user device that comprises processing circuitry and radio circuitry. The processing circuitry detects a slice handover requirement. The processing circuitry selects a network slice based at least on session requirements in response to the slice handover requirement. The radio circuitry wirelessly transfers a slice handover request that identifies the network slice to a wireless communication network. The wireless communication network performs a slice handover from a serving network slice to the network slice indicated in the slice handover request.

### TECHNICAL FIELD

Various embodiments of the present technology relate to network slicing, and more specifically, to facilitating user-initiated network slice handover.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless communication networks implement network slicing to serve wireless user devices. A network slice is a type of network partition that groups a set of RAN and core network resources that have capabilities to provide one or more service types. Network slices may be configured to provide low-latency services, media streaming services, Internet-of-Things (IoT) services, and the like. Exemplary slice types include Ultra-Reliable Low Latency Communication (URLLC), Enhanced Mobile Broadband (eMBB), Massive Internet-of-Things (MIoT), Massive Machine Type Communications (mMTC), and Vehicle-to-Everything (V2X). By implementing network slicing, wireless communication networks optimize the computing and radio resources for specific service types thereby enhancing the overall user experience.

When a user device attaches to a core network over a RAN, the core network assigns the user device to one or more network slices. The core network assigns the network slices based on factors like the session type of the user device, the user device's subscription, and slice requests from the user device. Once the slices are assigned, the user device begins data session(s) on the assigned slice(s). However, the session requirements of the user device may change over time. For example, the user device may launch a new user application, and the network slices initially assigned to the user device may not be optimized for the new user application. Unfortunately, in some instances, wireless communication networks may not effectively or efficiently serve user devices over network slices.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for network slicing. Some embodiments comprise a method. The method comprises detecting a slice handover requirement. The method further comprises selecting a network slice based on session requirements in response to the slice handover requirement. The method further comprises wirelessly transferring a slice handover request that identifies the network slice to a wireless communication network. The wireless communication network performs a slice handover from a serving network slice to the network slice indicated in the slice handover request.

Some embodiments comprise a user device. The user device comprises processing circuitry and radio circuitry. The processing circuitry detects a slice handover requirement. The processing circuitry selects a network slice based on session requirements in response to the slice handover requirement. The radio circuitry wirelessly transfers a slice handover request that identifies the network slice to a wireless communication network. The wireless communication network performs a slice handover from a serving network slice to the network slice indicated in the slice handover request.

Some embodiments comprise one or more non-transitory computer readable storage media having program instructions stored thereon. When executed by a computing system, the program instructions direct the computing system to perform operations. The operations comprise detecting a slice handover requirement in response to the launch of an application. The operations further comprise selecting a new network slice based on application requirements in response to the slice handover requirement. The operations further comprise directing a radio to wirelessly transfer a slice handover request that identifies the new network slice to a wireless communication network. The wireless communication network performs a slice handover from a serving network slice to the new network slice indicated in the slice handover request.

### DESCRIPTION OF THE DRAWINGS

Many aspects of the disclosure can be better understood with reference to the following drawings. The components in the drawings are not necessarily drawn to scale.

Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network.

FIG. 2 illustrates an exemplary operation of the communication network.

FIG. 3 illustrates another exemplary operation of the communication network.

FIG. 4 illustrates a Fifth Generation (5G) communication network.

FIG. 5 illustrates a 5G User Equipment (UE) in the 5G communication network.

FIG. 6 illustrates a 5G Radio Access Network (RAN) in the 5G communication network.

FIG. 7 illustrates network functions in the 5G communication network.

FIG. 8 illustrates a Network Function Virtualization Infrastructure (NFVI) in the 5G communication network.

FIG. 9 further illustrates the NFVI in the 5G communication network.

FIG. 10 illustrates an exemplary operation of the 5G communication network.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

Conventional slice handover is a network-controlled process and may be triggered by factors like slice loading, user device mobility, and the like. Conventional wireless communication networks often lack visibility of user device session requirements at any given time. The user device session requirements often change over time. As such, conventional networks may fail to detect when the capabilities of the serving network slice become misaligned with the user device's current session requirements. The misalignments of slice capabilities and session requirements degrades the overall user experience. When the capabilities of a network slice cannot adequately support the session requirements of a user device, the quality of the device's session may suffer. When the capabilities of a network slice overly support the session requirements of a user device, vital network resources are wasted.

Various embodiments of the present technology relate to user-initiated network slice handover to address the issues of conventional slice handover. In some examples, a user device monitors for slice handover requirements. Slice handover requirements may be detected in response to the launch of a user application when the capabilities of the serving network slice do not support the application type, Quality-of-Service (QoS) requirements, user preferences, or some other aspect of the application. In response to detecting the slice handover requirement, the user device selects a new network slice based on the device's session requirements. Typically, the user device compares the application type, QoS, user preferences, and/or other session requirements to the capabilities, network conditions, and operator policies of available network slices. The user device selects the available network slice best suited to support the session requirements based on the comparison. In doing so, the user device inhibits misalignment of network slice capabilities and user device session requirements. By inhibiting this misalignment, the overall user experience is improved, and network resources are conserved. The user device obtains the available slice information via retrieval (e.g., Application Programming Interface (API) call transfer to a network data entity) or via wireless broadcast (e.g., System Information Block (SIB) reception). The user device may display a prompt on its display screen allowing the user to trigger/approve the handover or the handover may be automatic.

Once the new network slice is selected, the user device wirelessly transfers a slice handover request that identifies the selected slice to the wireless communication network. The wireless communication network performs a slice handover from the serving network slice to the selected network slice indicated in the slice handover request. The slice handover request may include billing information that instructs the network to charge the user device for on-demand use of the selected network slice. When the request includes billing information, the wireless communication network generates a charge for on-demand use of the selected network slice based on the billing information. Now referring to the Figures.

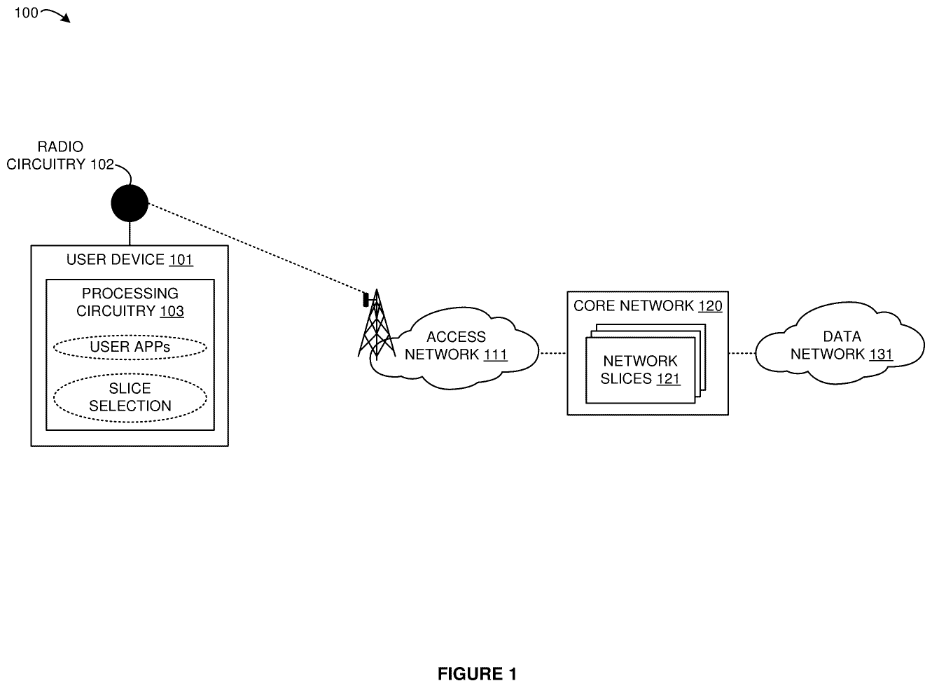

FIG. 1 illustrates communication network 100 to facilitate user-initiated network slice handover. Communication network 100 provides services like media-streaming, internet-access, voice/video calling, text messaging, online gaming, social media, machine communications, or some other wireless communications product. Communication network 100 comprises user device 101, access network 111, core network 120, and data network 131. User device 101 comprises radio circuitry 102 and processing circuitry 103. Processing circuitry 103 stores and executes user applications (APPs) and a slice selection application. Core network 120 comprises network slices 121. In other examples, communication network 100 may comprise additional or different elements than those illustrated in FIG. 1.

Various examples of network operation and configuration are described herein. In some examples, user device 101 participates in a data session with a serving one of network slices 121 in core network 120 over access network 111. An executing user application in user device 101 exchanges user data for the session with the serving one of network slices 121. The serving one of network slices 121 exchanges the user data for the session with data network 131. Processing circuitry 103 detects a slice handover requirement for user device 101. A slice handover requirement occurs when the capabilities of the serving network slice (e.g., supported Quality-of-Service (QoS)) do not support (or is some examples, excessively support) the requirements of the device's session (e.g., required QoS). Slice handover may be triggered by a new application launch, change in application type, change in Quality-of-Service (QoS) requirements, user preferences, and the like. For example, processing circuitry 103 may launch a new one of the user applications and determine the capabilities of the serving one of network slices 121 does not support the session requirements of the launched user application and responsively detect a slice handover requirement. In response to the handover requirement, processing circuitry 103 selects a new one of network slices 121 based on the session requirements. Processing circuitry 103 drives radio circuitry 102 to transfer a slice handover request to core network 120. Radio circuitry 102 wirelessly transfers the slice handover request that identifies the selected one of network slices 121 to core network 120 over access network 111. Core network 120 performs a slice handover of user device 101 from the serving one of network slices 121 to the selected one of network slices 121 indicated in the slice handover request.

User device 101 comprises a vehicle, drone, robot, computer, phone, sensor, or another type of data appliance with wireless and/or wireline communication circuitry. User device 101 and access network 111 communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access network 111 is illustrated as comprising a tower, access network 111 may comprise another type of mounting structure (e.g., a building), or no mounting structure at all. Access network 111 comprises a Sixth Generation (6G) Radio Access Network (RAN), Fifth Generation (5G) RAN, LTE RAN, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Access network 111 exchanges network signaling and user data with network functions clustered together into core network 120. Access network 111 is connected to core network 120 over backhaul data links. Access network 111 and core network 120 may communicate via edge networks like internet backbone providers, edge computing systems, or another type of edge system to provide the backhaul data links between access network 111 and core network 120.

Access network 111 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120.

Core network 120 is representative of computing systems that provide wireless data services to user device 101 over access network 111. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access network 111, core network 120, and data network 131 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols. The computing systems of core network 120 store and execute the network functions/entities to form network slices 121. The network functions are typically organized into a control plane and a user plane. The control plane may comprise network functions like Access and Mobility Management Function (AMF), Session Management Function (SMF), Authentication Server Function (AUSF), Network Slice Selection Function (NSSF), Network Slice Control Function (NSCF), Policy Control Function (PCF), Unified Data Management (UDM), Charging Function (CHF), and the like. The user plane may comprise network functions like User Plane Function (UPF) and the like.

Network slices 121 are representative of collections of network elements (e.g., UPFs, RAN elements, etc.) with capabilities to support different service types over access network 111. For example, a first one of network slices 121 may comprise low-latency capabilities to support low-latency data sessions while a second one of network slices 121 may comprise high-uplink bandwidth capabilities to support media broadcasting sessions. Exemplary network slice types include Ultra-Reliable Low-Latency Communications (URLLC), Enhanced Mobile Broadband (eMBB), Massive Internet-of-Things (MIoT), Massive Machine Type Communications (mMTC), Vehicle-to-Anything (V2X), and the like. While illustrated as residing entirely in core network 120, portions of network slices 121 may reside in access network 111 and/or in other locations within communication network 100.

Data network 131 comprises an Application Server (AS) that hosts applications (e.g., media streaming applications, social media applications, IoT applications, online gaming applications, etc.) for user device 101. Data network 131 may be representative of a public data network (e.g., the Internet) or a private data network (e.g., an enterprise network). Core network 120 and data network 131 may communicate via links provided by internet backbone providers, edge computing services, and/or other communication services that provide the data links between core network 120 and data network 131.

User device 101 and access network 111 comprise antennas, amplifiers, filters, modulation, analog/digital interfaces, microprocessors, software, memories, transceivers, bus circuitry, and the like. User device 101, access network 111, core network 120, and data network 131 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), analog processing units, and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, slice selection applications, and network functions. The microprocessors retrieve the software from the memories and execute the software to drive the operation of communication network 100 as described herein.

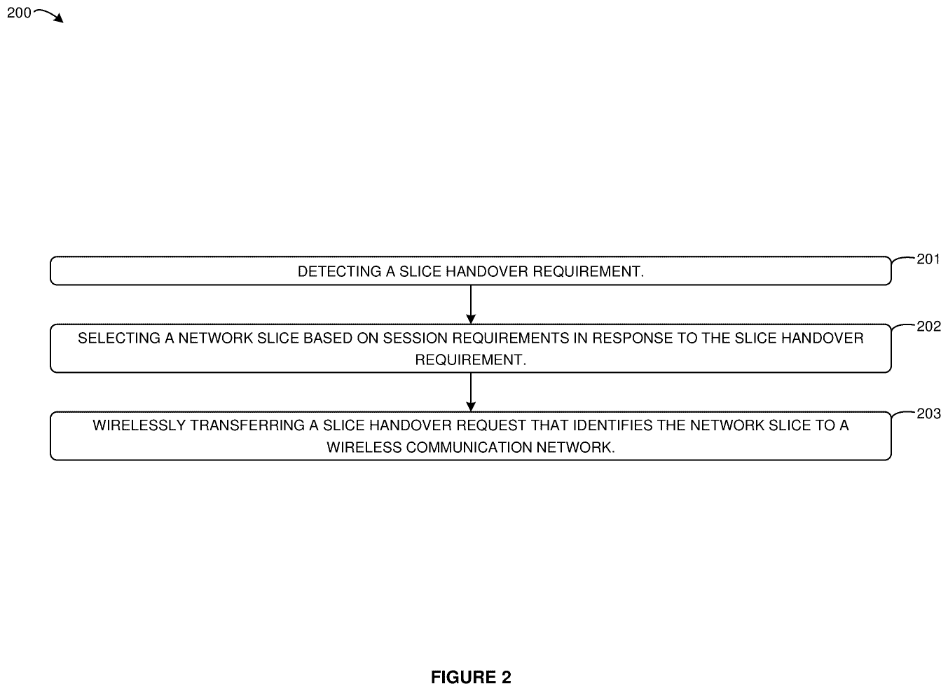

FIG. 2 illustrates process 200. Process 200 comprises an exemplary operation of communication network 100 to facilitate user-initiated slice handover. Process 200 may vary in other examples. The operations of process 200 comprise detecting a slice handover requirement (step 201). The operations further comprise selecting a network slice based on session requirements in response to the slice handover requirement (step 202). The operations further comprise wirelessly transferring a slice handover request that identifies the network slice to a wireless communication network (step 203). The wireless communication network performs a slice handover from a serving network slice to the network slice indicated in the slice handover request.

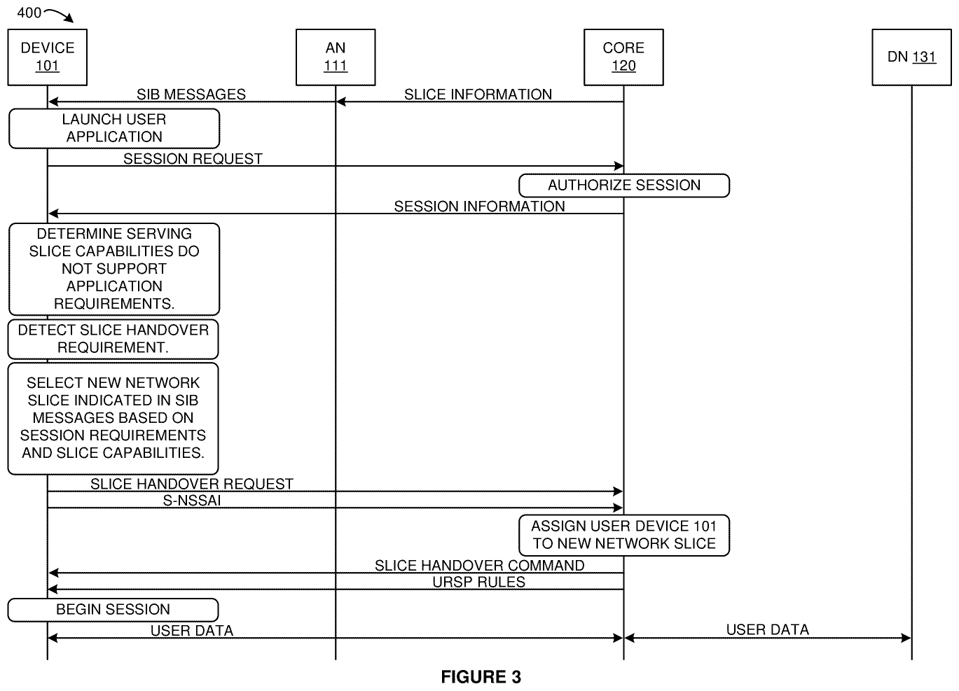

FIG. 3 illustrates process 300. Process 300 comprises an exemplary operation of communication network 100 to facilitate user-initiated slice handover. Process 300 comprises an example of processes 200 illustrated in FIG. 2, however process 200 may differ. Process 300 may vary in other examples. In some examples, user device 101 attaches to core network 120 over access network 111. User device 101 transfers a registration request to core network 120. The registration request includes information like subscriber Identifiers (ID), device capabilities, slice requests, and the like. Core network 120 authenticates user device 101 and authorizes user device 101 for service on communication network 100. Core network 120 assigns user device 101 to an initial one of network slices 121 based on the registration request and/or subscriber attributes of user device 101 stored on a network data system (not illustrated) in core network 120. For example, user device 101 may include a slice request for the initial one of network slices 121 in the registration request.

Core network 120 transfers slice information to access network (AN) 111 and directs access network 111 to broadcast the slice information. The slice information indicates the availability over access network 111, capabilities (e.g., latency, throughput, supported QoS, etc.), loading information, operator rules (e.g., usage pricing), and/or other slice related information for network slices 121. Access network 111 generates and broadcasts System Information Blocks (SIBs) that include the slice information. Radio circuity 102 in user device 101 wirelessly receives the SIBs and provides the SIBs processing circuitry 103. Processing circuitry 103 reads the SIBs to determine the slice information.

User device 101 receives a user input that directs user device 101 to launch a user application. For example, the user of user device 101 may wish to launch a media streaming application, media broadcasting application, gaming application, social media application, internet browser application, and/or some other type of user application. Processing circuitry 103 launches the user application in response to the user input. Processing circuitry 103 generates a request for a Protocol Data Unit (PDU) session for the application and drives radio circuitry 102 to transfer the PDU session request. Radio circuitry 102 wirelessly transfers the session request for delivery to core network 120. Core network 120 accesses user device 101's subscriber profile to authorize the PDU session and returns session information to user device 101 over access network 111. The session information includes a session approval, Internet Protocol (IP) addresses, Tunnel Endpoint ID (TEID) addresses, and/or other data for user device 101 to begin the PDU session.

Radio circuitry 102 wirelessly receives the session information and provides the session information to processing circuitry 103. Processing circuitry 103 compares the requirements of the user application's PDU session to the slice information for the serving one of network slices 121 (i.e., the network slice initially assigned to user device 101 during registration). Processing circuitry 103 determines the capabilities of the serving one of network slices 121 do not support the requirements of the user application's PDU session or are otherwise not optimized for the requirements of the user application's PDU session. For example, the QoS, supported latency, supported throughput, and/or some other capability of the serving one of network slices 121 may be less than the required QoS, required latency, required throughput, and/or some other requirement of the user application's PDU session. In response, processing circuitry 103 detects a slice handover requirement. Processing circuitry 103 compares the slice information of network slices 121 available over access network 111 received in the SIB messages to the user application's PDU session requirements. Processing circuitry 103 selects one of network slices 121 with capabilities that support the requirements of the user application. Processing circuitry 103 may host a data structure, machine learning algorithm, optimization algorithm, rules-based decision matrix, and/or some other type of program to select network slices for handover. For example, processing circuitry 103 may implement a weighted sum function to score the suitability of the available ones of network slices 121 and select the one of network slices 121 with the highest suitability score for handover.

Processing circuitry 103 generates a slice handover request that includes the Single-Network Slice Selection Assistance Information (S-NSSAI) for the selected one of network slices 121. An S-NSSAI is a network code that identifies network slice types and/or individual network slices. Processing circuitry 103 drives radio circuitry 102 to wirelessly transfer the slice handover request for delivery to core network 120. Core network 120 approves the request and reassigns user device 101 to the selected one of network slices 121 based on the S-NSSAI included in the handover request. Core network 120 transfers a slice handover command to user device 101 over access network 111. The slice handover command sent to user device 101 acknowledges the handover, includes address information for the new network slice, and includes User Equipment Route Selection Policy (URSP) rules. The URSP rules control user device 101 to route user data for the user application's PDU session to the selected one of network slices 121.

Radio circuitry 102 wirelessly receives the slice handover command and forwards the command to processing circuitry 103. Processing circuitry 103 directs the user application to begin the PDU session. The user application generates user data for the PDU session.

Processing circuitry 103 drives radio circuitry 102 to wirelessly exchange the user data with the selected one of network slices 121 over access network 111 based on the URSP rules. The selected one of network slices 121 exchanges the user data with data network (DN) 131.

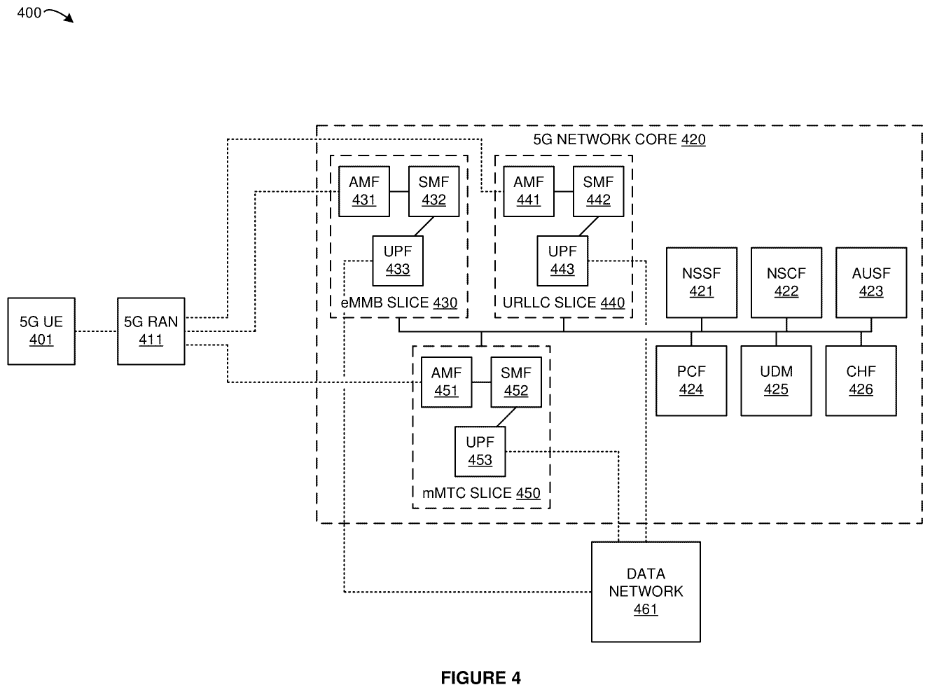

FIG. 4 illustrates 5G communication network 400 to facilitate user-initiated slice handover. 5G communication network 400 comprises an example of communication network 100 illustrated in FIG. 1, however network 100 may differ. 5G communication network 400 comprises 5G User Equipment (UE) 401, 5G RAN 411, 5G network core 420, and data network 461. 5G network core 420 comprises eMBB slice 430, URLLC slice 440, mMTC slice 450, NSSF 421, NSCF 422, AUSF 423, PCF 424, UDM 425, and CHF 426. eMBB slice 430 comprises AMF 431, SMF 432, and UPF 433. URLLC slice 440 comprises AMF 441, SMF 442, and UPF 443. mMTC slice 450 comprises AMF 451, SMF 452, and UPF 453. Other network functions and network entities like Unified Data Registry (UDR), Home Subscriber Register (HLR), Home Subscriber Server (HSS), Network Repository Function (NRF), Short Message Service Function (SMSF), Network Exposure Function (NEF), Application Function (AF), Equipment Identity Register (EIR), and Session Communication Proxy (SCP) are typically present in 5G network core 420 but are omitted for clarity. In other examples, 5G communication network 400 may comprise different or additional elements than those illustrated in FIG. 4.

In some examples, UE 401 launches a user application with high bandwidth application requirements (e.g., a media streaming application). UE 401 wirelessly attaches to 5G RAN 411 over a 5GNR link. UE 401 undergoes a Random Access Channel (RACH) procedure with 5G RAN 411 to establish a secure signaling channel. In this example, UE 401 initially attaches to AMF 431 in eMBB slice 430, however UE 401 may initially attach to a different AMF in 5G network core 420 in other examples. UE 401 transfers a registration request to AMF 431 over 5G RAN 411. The registration request indicates a registration type, 5G-Global Unique Temporary Identifier (GUTI), Tracking Area Identifier (TAI), an NSSAI request for an eMBB slice, UE capabilities, PDU session requests, and the like. When UE 401 launches a different application with different application requirements (e.g., a low-latency application), UE 401 may include an NSSAI request for a different network slice (e.g., a URLLC slice).

In response to the registration request, AMF 431 transfers a Non-Access Stratum (NAS) identity request to UE 401 over a NAS signaling link between UE 401 and AMF 431 that traverses 5G RAN 411. UE 401 indicates its Subscriber Concealed Identifier (SUCI) to AMF 431 over the NAS link that traverses 5G RAN 411. AMF 431 transfers an authentication request to AUSF 423 to retrieve authentication vectors to authenticate UE 401. The request comprises the SUCI for UE 401. AUSF 423 indicates the SUCI and requests authentication vectors from UDM 425. UDM 425 accesses the subscriber profile for UE 401 and derives the Subscriber Permanent Identifier (SUPI) for UE 401 based on the SUCI. UDM 425 generates authentication vectors for UE 401 and returns the vectors and SUPI to AUSF 423. The authentication vectors comprise a random number, expected result, key selection criteria, and the like. AUSF 423 forwards the SUPI and authentication vectors to AMF 431. AMF 431 transfers an authentication challenge that comprises the random number and key selection criteria to UE 401 over the NAS link that traverses 5G RAN 411. UE 401 hashes random number with its secret key to generate an authentication result and indicates the authentication result to AMF 431 over the NAS link. AMF 431 matches the expected result retrieved from AUSF 423 with the authentication result received from UE 401 to authenticate UE 401.

Responsive to the authentication, AMF 431 transfers a context registration request to UDM 425 that includes AMF ID, a supported feature list, a Permanent Equipment Identifier (PEI) for UE 401, and the like. UDM 425 indicates successful UDM registration to AMF 431. In response, AMF 431 requests access and mobility subscription data, SMF selection subscription data, and UE context in SMF data from UDM 425. UDM 425 accesses the subscriber profile for UE 401 (e.g., stored in a UDR) and returns the requested data. The access and mobility subscription data comprises a supported feature list for UE 401 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. AMF 431 forms the UE context for UE 401 using the retrieved information. The UE context defines the authorized services for UE 401.

AMF 431 interfaces with NSSF 421 to select an initial network slice (or slices) for UE 401 based on the slice selection information, NSSAI list provided by UE 401 in the registration request, and the allowed NSSAIs indicated in the subscriber profile. Wireless network slices typically comprise collections of core network and RAN resources that have capabilities to provide service types (e.g., low-latency service) to UEs. In this example, 5G network core 420 comprises an eMBB slice, an mMTC slice, and a URLLC slice. The network functions of eMBB slice 430 comprise capabilities to support high-bandwidth PDU sessions. The network functions of URLLC slice 440 comprise capabilities to low-latency PDU sessions. The network functions of mMTC slice 450 comprise capabilities to support low-bandwidth, latency insensitive Internet-of-Things (IoT) PDU sessions. NSCF 422 maintains a slice catalog that tracks metrics for slices 430, 440, and 450 like capabilities (e.g., supported latency, load, QoS), load, supported geographic location, operator defined rules (e.g., pricing, Service Level Agreements (SLAs), etc.), and the like. Although illustrated as only comprising AMFs, SMFs, and UPFs, network slices 430, 440, and 450 may comprise other network elements in 5G communication network 400. Moreover, some elements may be shared between different ones of the network slices. For example, AMF 441 may be omitted, and AMF 431 may be shared between eMBB slice 430 and URLLC slice 440. It should be appreciated that 5G communication network 400 typically comprises many more network slices and slice types and that three distinct slices are shown for clarity.

AMF 431 selects NSSF 421 to initiate network slice selection for UE 401. AMF 431 transfers a network slice selection get request to NSSF 421. The request indicates the list of allowed S-NSSAIs for UE 401 retrieved from UDM 425, the S-NSSAIs requested by UE 401 received in the registration request, and/or other slice selection information. NSSF 421 maps the requested S-NSSAI that corresponds to an allowed S-NSSAIs to a network slice instance in 5G network core 420. In this example, since UE 401 provided an NSSAI for an eMBB slice in the registration request, NSSF 421 maps the S-NSSAI to eMBB slice 430 and returns the network slice instance ID for eMBB slice 430 to AMF 431. NSSF 421 may also return a list of SMFs that can support the mapped network slices. When NSSF 421 maps the S-NSSAI selected by UE 401 to URLLC slice 440 or mMTC slice 450, NSSF 421 reselects the AMF for UE 401 and directs AMF 431 to transfer UE 401 to the selected AMF (e.g., AMF 441 or AMF 451) that supports the mapped S-NSSAI. For example, if NSSF 421 maps the S-NSSAI to URLLC slice 440, NSSF 421 may notify AMF 431 and AMF 431 may interface with AMF 441 to transfer the UE 401 to AMF 441.

AMF 431 transfers a policy creation request to PCF 424 to create a policy association for UE 401. PCF 424 responds to the request with policy association information like the SUPI, GPSI, PEI, and user location information for UE 401. The policy association information includes URSP rules that drive UE 401 to route user data for its sessions to UPF 433 in eMBB slice 430. PCF 424 subscribes to AMF 431 for event reporting like user location updates, registration state changes, communication failure events, and the like. AMF 431 creates a PCF subscription based on the policy association information and signals PCF 424 of the successful subscription creation.

AMF 431 selects SMF 432 to serve UE 401 based on SMF selection data received from UDM 425, the network policies received from PCF 424, and/or the network slice(s) selected by NSSF 421. AMF 431 transfers a list of requested PDU sessions (as received during the registration request), a PDU session activation command, and the SUPI to SMF 432. SMF 432 receives the PDU session list, session activation command, and the SUPI from AMF 431. SMF 432 selects UPF 433 to support the PDU session. SMF 432 allocates IP addresses to UE 401 for the requested PDU sessions and allocates Tunnel End Point ID (TEID) for the session. SMF 432 transfers a session modification request that includes a session endpoint identifier, IP address, MSISDN, session start/stop information, and TEID to UPF 433 to set up the PDU sessions for UE 401. UPF 433 sets up a default bearer for UE 401 that traverses 5G RAN 411. The default bearer is a link to carry IP packets for UE 401's PDU session(s).

SMF 432 notifies AMF 431 that the default bearer is set up. In response, AMF 431 registers UE 401 for service on 5G network core 420. AMF 431 generates a registration accept message that includes the URSP rules, the allocated IP address for UE 401, RAN ID, AMBR, Globally Unique AMF ID (GUAMI), PDU session data, S-NSSAI list, security data, and the like. AMF 431 transfers the registration accept message to UE 401 over the NAS link that traverses 5G RAN 411. UE 401 receives the registration accept message and directs the high bandwidth user application to begin the PDU session based on the registration accept message. The application generates user data. UE 401 wirelessly exchanges the user data for the PDU session with UPF 433 in eMBB slice 430 over the default bearer that traverses 5G RAN 411 based on the URSP rules provided by PCF 424. UPF 433 exchanges the user data with data network 461. UPF 433 reports usage data to CHF 426 which generates a change for UE 401's service over eMBB slice 430.

Subsequently, UE 401 receives a user input closing the high-bandwidth application and launching a latency sensitive application (e.g., an online gaming application). UE 401 ends the PDU session for the high-bandwidth user application. UE 401 compares the application requirements of the latency sensitive application to the capabilities of eMBB slice 430. For example, UE 401 may compare the QoS, throughput, latency, user preferences, and operator rules for the latency sensitive application to the capabilities supported by eMBB slice 430 (e.g., supported QoS, supported throughput, supported latency, operator rules, etc.). When the capabilities of the serving slice (i.e., eMBB slice 430) cannot support and/or are not optimized to support the requirements of the executing application (i.e., the latency sensitive application), UE 401 detects a slice handover requirement.

In some examples, UE 401 may utilize one or more thresholds, algorithms, and/or other types of data structures to detect when slice handover requirements occur. UE 401 may measure performance of the network slice to detect slice handover requirements and compare the measured performance to corresponding thresholds to detect slice handover requirements. For example, UE 401 may measure the latency and throughput of the serving network slice and detect a slice handover requirement when the measured performance data falls below the corresponding threshold (e.g., 20 ms). These performance thresholds may be application/session specific and may vary depending on the UE 401's current session/application requirements. UE 401 may also obtain the slice performance data by querying a network data system that stores slice performance data (e.g., NSCF 422) or may receive the slice performance data via broadcast by RAN 411 (e.g., via SIB message). UE 401 may also detect slice handover requirements when UE 401's current session is excessively supported by the network slice (e.g., supported slice capabilities exceed application/PDU session requirements by a threshold level). For example, UE 401 may measure the bandwidth usage (or other performance metrics) of its PDU session and detect a slice handover requirement when the bandwidth supported by the network slice exceeds the measured bandwidth by a threshold amount (e.g., 50%).

Returning to the present example, in response to the handover requirement, UE 401 identifies a new network slice that supports the requirements of the latency sensitive application. UE 401 compares to the QoS, throughput, latency, user preferences, operator rules, and/or other requirements of the latency sensitive application to the supported QoS, supported throughput, supported latency, slice Key Performance Indicators (KPIs), and/or other supported capabilities of the network slices available over 5G RAN 411 to identify the new slice. UE 401 may also assess other factors like slice loading, operator rules (e.g., cost), and user preferences (slice blacklists, slice whitelists, preferred slices, etc.) to identify the new slice. UE 401 may obtain information (e.g., capability information, slice KPIs, etc.) of the slices available over 5G RAN 411 by retrieving the information from NSCF 422 (e.g., via API request) and/or the slice information may be broadcast to UE 401 (e.g., via SIB message). UE 401 may host a machine learning model, rules-based engine, optimization engine, and/or some other form of data structure to select new slices for slice handover based on application requirements and slice capabilities.

In this example, UE 401 identifies URLLC slice 440 as the most suitable network slice to support a PDU session for the latency sensitive application. UE 401 generates a slice handover request that includes the S-NSSAI for a URLLC slice, a PDU session request for the latency sensitive application, and billing information to charge UE 401 for use of the slice usage. UE 401 wirelessly transfers the slice handover request to AMF 431. UE 401 may transfer the request automatically or in response to a user request (e.g., a user input in response to displaying slice handover prompt). For example, UE 401 may display a prompt notifying the user of the slice handover requirement and the selected network slice and the user may provide an input via the prompt to trigger the slice handover. While UE 401 is described as selecting the network slice for slice handover, in other examples, 5G network core 420 may select the new network slice on behalf of UE 401 to perform the handover. For example, NSSF 421 may interface with NSCF 422 to select and hand over UE 401 from a first slice to a second slice in response to receiving a slice handover request from UE 401. Like UE 401, NSSF 421 and/or NSCF 422 may host machine learning engines, decision matrices, optimization engines, and/or other data structures to correlate application requirements (e.g., QoS, latency, throughput, etc.) to slice capabilities/conditions (supported QoS, supported throughput, supported latency, load, location-based availability, price, etc.) to select network slices for handover.

AMF 431 receives the slice handover request from UE 401 and forwards the request to NSSF 421 to map the S-NSSAI included in the request to a network slice instance in 5G network core 420. NSSF 421 maps the S-NSSAI for a URLLC slice to URLLC slice 440. NSSF 421 returns the slice ID for URLLC slice 440 to AMF 431. AMF 431 transfers a slice handover required message to AMF 441 in URLLC slice 440. The handover required message includes the PDU session request for the low-latency application. AMF 431 directs SMF 432 to tear down the default bearer for UE 401 on eMBB slice 430. SMF 432 controls UPF 433 to tear down the default bearer. AMF 431 transfers a slice handover notification to UE 401 that indicates the slice handover is complete as well as the AMF ID for AMF 441, endpoint addresses, and/or other information for UE 401 to use to communicate with URLLC slice 440 over 5G RAN 411. UE 401 uses the received information to establish a NAS signaling link with AMF 441 over 5G RAN 411.

AMF 441 receives the slice handover required message. AMF 441 retrieves the UE context for UE 401 from AMF 431 and maintains the registration of UE 401 on 5G network core 420 based on the prior authentication/authorization. AMF 441 selects SMF 442 to serve UE 401 based on UE context retrieved from AMF 431. AMF 441 directs SMF 442 to set up the requested PDU session for the latency sensitive application of UE 401. SMF 442 allocates IP addresses to UE 401 and TEID for the requested PDU session. SMF 442 controls UPF 443 to establish a default bearer over 5G RAN 411 to support the session. UPF 443 sets up a default bearer for UE 401 that traverses 5G RAN 411. SMF 442 notifies AMF 441 that the PDU session is ready to begin. AMF 441 retrieves URSP rules from PCF 424 that drive UE 401 to route data for the PDU session of the latency sensitive application to UPF 443. AMF 441 transfers a session start command to UE 401 over the NAS link that directs UE 401 to begin the PDU session for the latency sensitive application. The command includes the URSP rules, IP addresses, TEID, and/or other session context information UE 401 needs to begin the session. UE 401 receives the message and directs the latency sensitive user application to begin the PDU session. The latency sensitive application generates user data and UE 401 wirelessly exchanges the user data for the PDU session with UPF 443 in URLLC slice 440 based on the URSP rules. UPF 443 exchanges the user data with data network 461 and reports usage data to CHF 426. CHF 426 generates a change for UE 401's service over URLLC slice 440.

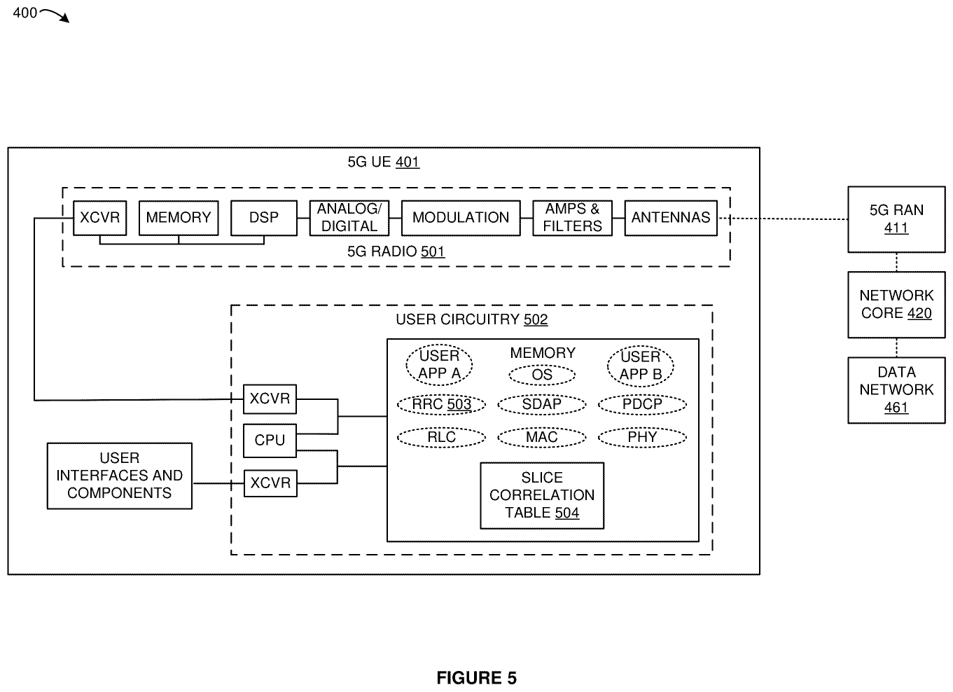

FIG. 5 illustrates UE 401 in 5G communication network 400. UE 401 comprises an example of user device 101 illustrated in FIG. 1, although user device 101 may differ. UE 401 comprises 5G radio 501 and user circuitry 502. 5G radio 501 comprises 5GNR antennas, amplifiers, filters, modulation, analog-to-digital interfaces, Digital Signal Processers (DSP), memory, and transceivers (XCVRs) that are coupled over bus circuitry. User circuitry 502 comprises memory, CPU, user interfaces and components, and transceivers that are coupled over bus circuitry.

The memory in user circuitry 502 stores an operating system (OS), user applications (illustrated as user applications A and B), 5GNR network applications for PHY, MAC, RLC, PDCP, SDAP, and RRC 503, and slice correlation table 504. The antenna in 5G radio 501 is wirelessly coupled to 5G RAN 411 over a 5GNR link. Transceivers in radio 501 are coupled to a transceiver in user circuitry 502. A transceiver in user circuitry 502 is typically coupled to user interfaces and components like displays, controllers, and memory.

In 5G radio 501, the antennas receive wireless signals from 5G RAN 411 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 502 over the transceivers. In user circuitry 502, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 501, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 411 that transport the uplink 5GNR signaling and data.

RRC 503 functions comprise authentication, security, handover control, status reporting, QoS, network broadcasts and pages, network selection, slice handover requirement detection, new slice selection, and slice handover initiation. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). Slice correlation table 504 is representative of a data structure that correlates application requirements to suitable network slices. For example, correlation table 504 may associate application requirements like application type, throughput, latency, QoS, and user preferences with network slice capabilities like supported QoS, throughput, and latency, as well as other factors like slice load, location, and price to detect slice handover conditions and select network slices for slice handover.

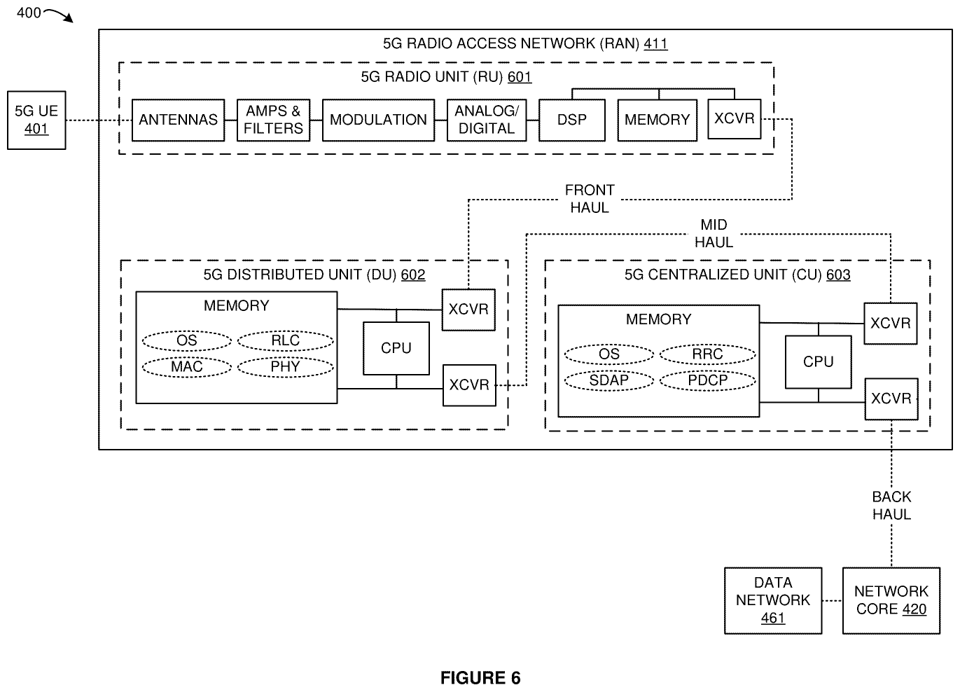

FIG. 6 illustrates 5G RAN 411 in 5G communication network 400. 5G RAN 411 comprises an example of the access network 111 illustrated in FIG. 1, although access network 111 may differ. RU 601 comprises 5GNR antennas, amplifiers, filters, modulation, analog-to-digital interfaces, DSP, memory, and transceivers (XCVRs) that are coupled over bus circuitry. UE 401 is wirelessly coupled to antennas in 5G RU 601 over 5GNR links. Transceivers in 5G RU 601 are coupled to transceivers in DU 602 over fronthaul links like enhanced Common Public Radio Interface (eCPRI). The DSPs in RU 601 executes their operating systems and radio applications to exchange 5GNR signals with UE 401 and to exchange 5GNR data with DU 602.

For the uplink, the antennas in RU 601 receive wireless signals from UE 401 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 602 over the transceivers.

For the downlink, the DSPs receive downlink 5GNR symbols from DU 602. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 401 that transport the downlink 5GNR signaling and data.

DU 602 comprises memory, CPU, and transceivers that are coupled over bus circuitry. The memory in DU 602 stores operating systems and 5GNR network applications like PHY, MAC, and RLC. CU 603 comprises memory, CPU, and transceivers that are coupled over bus circuitry. The memory in CU 603 stores an operating system and 5GNR network applications like PDCP, SDAP, and RRC. Transceivers in DU 602 are coupled to transceivers in RU 601 over front-haul links. Transceivers in DU 602 are coupled to transceivers in CU 603 over mid-haul links. A transceiver in CU 603 is coupled to 5G network core 420 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

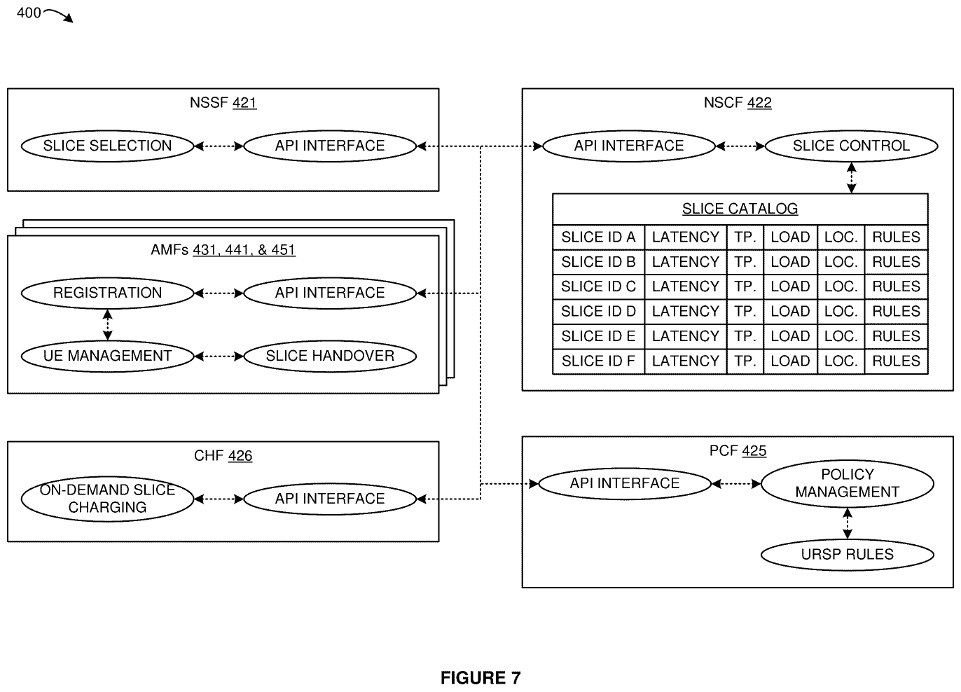

FIG. 7 illustrates NSSF 421, NSCF 422, PCF 424, CHF 426, and AMFs 431, 441, and 451 in 5G communication network 400. In some examples, the network functions illustrated in FIG. 7 each comprise an API interface. The API interfaces allow the network functions to communication with each other and with external systems like 5G RAN 411, UE 401, and data network 461. NSSF 421 comprises a slice selection module. The slice selection module maps S-NSSAIs to network slice instances in 5G network core 420 for initial slice selection and slice handover. AMFs 431, 441, and 451 comprise modules for UE registration, UE connection and mobility management, and slice handover. The registration module handles registration signaling, authentication, and authorization. The management module controls mobility handover and connection teardown/setup. The slice handover module fields UE initiated slice handover requests, interfaces with other AMFs for slice handover, and transfers UE context during slice handover. CHF 426 comprises an on-demand slice charging module. The charging module meters slice usage by UE 401 and generates bills based on the amount of data, time of use, and/or some other usage metric. By generated on-demand usage charges for UE 401, UE 401 may be served network slices it is not subscribed but still bill UE 401 for the usage. PCF 425 comprises modules for policy management and URSP rules selection. The policy management module enforces policies for UE 401 based on UE 401's subscription on 5G network core 420. The URSP rules module selects rules for UE 401 to route traffic to the appropriate network slice.

NSCF 422 comprises a slice control module and stores a slice catalog. The slice control module manages hardware and software resources allocated to slices 430, 440, and 450, tracks slice metrics (e.g., loading, capabilities, etc.), manages slice lifecycles (e.g., instantiation/termination), and serves slice information to facilitate slice selection for slice handover. For example, the slice control module may interface with an Orchestration and Management (OAM) system to reserve computing resources (e.g., CPU, RAM, disk memory, etc.) for eMBB slice 430. The slice control module may serve the slice information in response to API calls and/or may provide the slice information to 5G RAN 411 for SIB message broadcast. The slice management module may enforce slice specific policies (e.g., access control policies, QoS policies, traffic management policies, etc.) to ensure slices 430, 440, and 450 comply with SLAs. The slice catalog comprises a database that indicates the slices in 5G network core 420 as well as capability information and other metrics for the slices. In this example, the slice catalog tracks the latency, throughput (TP.) load, location (LOC.) and operator rules for slice IDs A-F. In other examples, the slice catalog may include additional or different information that characterizes the available slices in 5G core network 420.

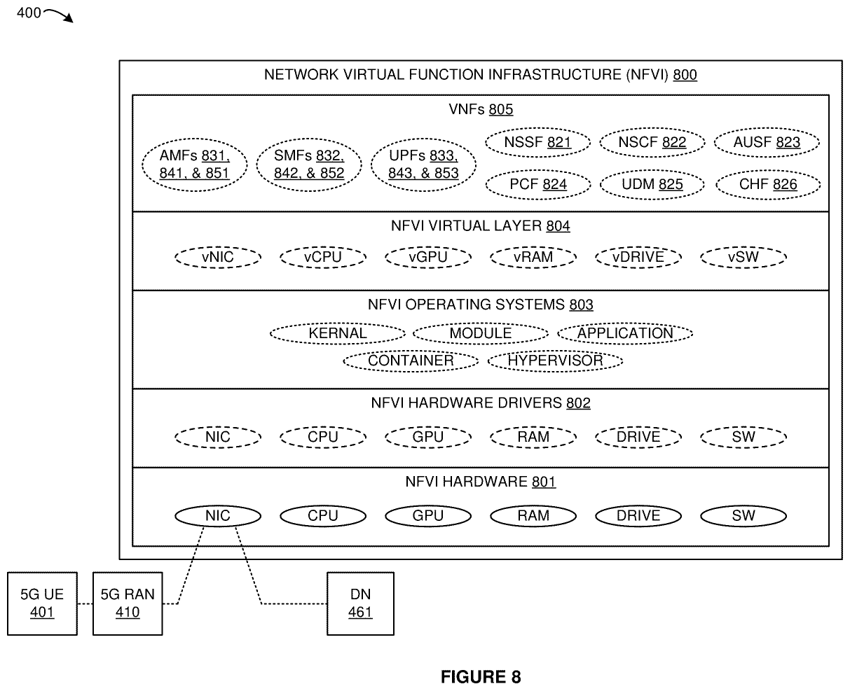

FIG. 8 illustrates Network Function Virtualization Infrastructure (NFVI) 800 in 5G wireless communication network 400. NFVI 800 comprises an example of core network 120 illustrated in FIG. 1, although core network 120 may differ. NFVI 800 comprises NFVI hardware 801, NFVI hardware drivers 802, NFVI operating systems 803, NFVI virtual layer 804, and NFVI Virtual Network Functions (VNFs)/Cloud-Native Network Functions (CNFs) 805. NFVI hardware 801 comprises Network Interface Cards (NICs), CPU, GPU, RAM, Flash/Disk Drives (DRIVE), and Data Switches (SW). NFVI hardware drivers 802 comprise software that is resident in the NIC, CPU, GPU, RAM, DRIVE, and SW. NFVI operating systems 803 comprise kernels, modules, applications, containers, hypervisors, and the like. NFVI virtual layer 804 comprises vNIC, vCPU, vGPU, vRAM, vDRIVE, and vSW. NFVI VNFs/CNFs 805 comprise AMFs 831, 841, and 851, SMFs 832, 842, and 852, UPFs 833, 843, and 853, NSSF 821, NSCF 822, AUSF 823, PCF 824, UDM 825, and CHF 826. Additional VNFs/CNFs like UDR, HLR, HSS, NRF, SMSF, NEF, AF, EIR, and SCP are typically present but are omitted for clarity. NFVI 800 may be located at a single site or be distributed across multiple geographic locations. The NIC in NFVI hardware 801 is coupled to 5G RAN 411, data network 461, and to external systems (not illustrated). NFVI hardware 801 executes NFVI hardware drivers 802, NFVI operating systems 803, NFVI virtual layer 804, and NFVI VNFs/CNFs 805 to form AMFs 431, 441, and 451, SMFs 432, 442, and 452, UPFs 433, 443, and 453, NSSF 421, NSCF 422, AUSF 423, PCF 424, UDM 425, and CHF 426.

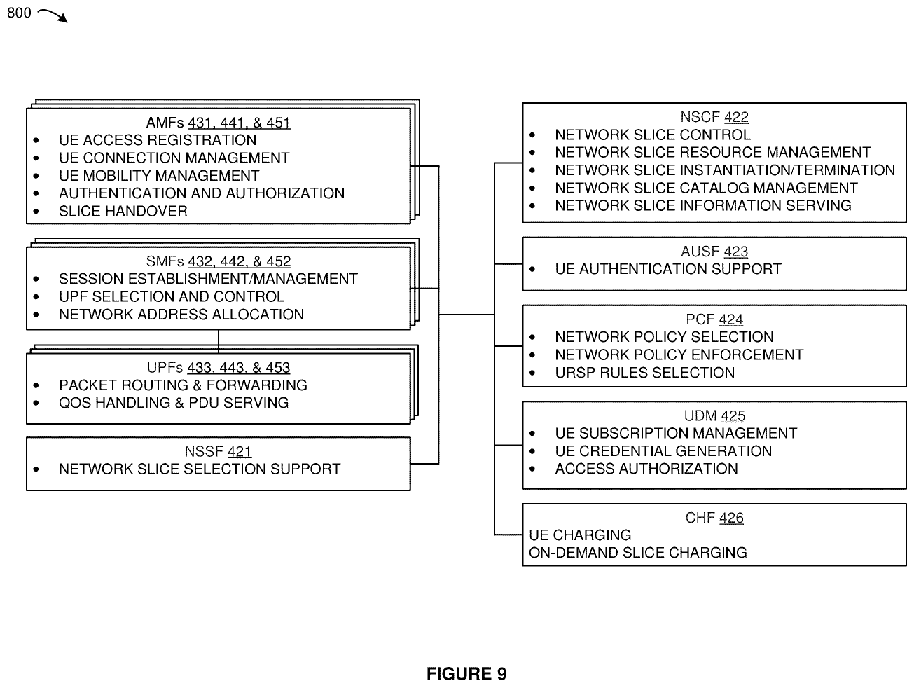

FIG. 9 further illustrates NFVI 800 in 5G communication network 400. AMFs 431, 441, and 451 comprise capabilities for UE registration, UE connection management, UE mobility management, authentication, authorization, and slice handover. SMFs 432, 442, and 452 comprise capabilities for session establishment, session management, UPF selection, UPF control, and network address allocation. UPFs 433, 443, and 453 comprise capabilities for packet routing, packet forwarding, QoS handling, and PDU serving. NSSF 421 comprises capabilities for network slice selection support. NSCF 422 comprises capabilities for network slice control, network slice resource management, network slice instantiation/termination, network slice catalog management, and network slice information serving. AUSF 423 comprises capabilities for UE authentication support. PCF 424 comprises capabilities for network policy selection, network policy enforcement, and URSP rules selection. UDM 425 comprises capabilities for UE subscription management, UE credential generation, and access authorization. CHF 426 comprises capabilities for UE charging and on-demand slice charging.

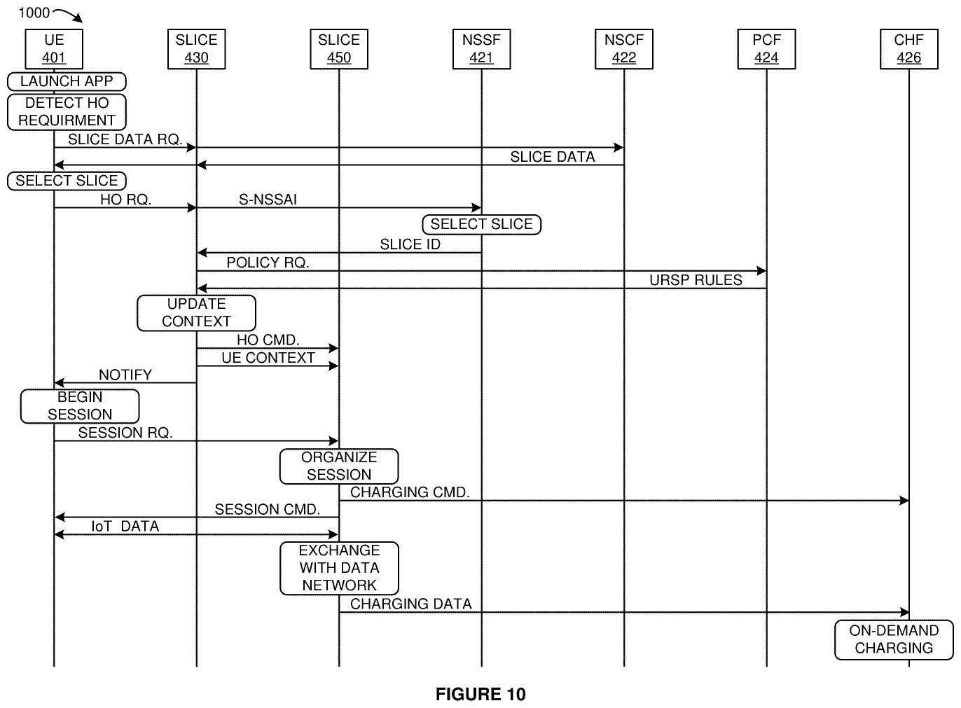

FIG. 10 illustrates process 1000. Process 1000 comprises an exemplary operation of 5G communication network 400 to facilitate user-initiated slice handover. Process 1000 comprises an example of processes 200 and 300 illustrated in FIGS. 2 and 3, however processes 200 and 300 may differ. Process 1000 may vary in other examples. In some examples, UE 401 initially attaches to 5G network core 420 and begins a PDU session on eMBB slice 430 for a bandwidth intensive media streaming application. Subsequently, the display of UE 401 receives a user input closing the high-bandwidth media streaming application and launching a resource metering IoT application. RRC 503 in UE 401 detects the user input and responsively directs the SDAP in UE 401 to end the PDU session for the media streaming application. RRC 503 accesses the slice correlation table stored in UE 401 and determines the capabilities of eMBB 430 are not optimized for the resource metering IoT application. For example, correlation table 504 may indicate the bandwidth allocation and monetary cost for using eMBB slice 430 are excessive for the resource metering IoT application which is latency insensitive and requires low bandwidth. In response, RRC 503 detects a slice handover requirement based on the output from correlation table 504. RRC 503 transfers an API call comprising a slice data request (RQ.) to the RRC in CU 603 over the PDCPs, RLCs, MACs, and PHYs. The RRC in CU 603 forwards the API call to NSCF 422. NSCF 422 accesses the slice catalog and generates an API response comprising the load, capabilities, and operator policies for network slices 440, and 450. NSCF 422 transfers the API response to the RRC in CU 603 which forwards the response to RRC 503 over the PDCPs, RLCs, MACs, and PHYs.

RRC 503 compares the slice information received in the API response to the requirements of the resource metering IoT application. RRC 503 selects mMTC slice 450 for handover based on the comparison. RRC 503 generates a slice handover request (HO RQ.) that includes the S-NSSAI for mMTC slice 530, a PDU session request for the resource metering application, and billing information (e.g., charging rate) to charge UE 401 for use of mMTC slice 450. RRC 503 transfers the slice handover request to the RRC in CU 603 over the PDCPs, RLCs, MACs, and PHYs. The RRC in CU 603 forwards the slice handover request to AMF 431.

AMF 431 receives the slice handover request from UE 401 and triggers slice handover. AMF 431 forwards the request to NSSF 421 to map the S-NSSAI for mMTC slice 450 included in the request to a network slice instance in 5G network core 420. NSSF 421 maps the S-NSSAI to mMTC slice 450 and returns the network slice instance ID for mMTC slice 450 to AMF 431. AMF 431 directs SMF 432 to tear down the default bearer for UE 401 on eMBB slice 430 and SMF 432 controls UPF 433 to tear down the default bearer. AMF 431 requests updated network policies from PCF 424 to route PDU session data from UE 401 to mMTC slice 450 and PCF 424 returns corresponding URSP rules. AMF 431 updates the UE context for UE 401 with the URSP rules (and potentially other data to switch the slice of UE 401). AMF 431 transfers a slice handover command and the updated context to AMF 451 in mMTC slice 450.

AMF 451 receives the slice handover command and updated UE context. AMF 451 updates the registration of UE 401 to reflect the slice handover. AMF 451 selects SMF 452 to serve UE 401 based on UE context and directs SMF 452 to set up the requested PDU session for the resource metering application of UE 401. SMF 452 allocates addresses for the session and controls UPF 453 to establish a default bearer over 5G RAN 411 to support the session. UPF 453 sets up a default bearer for UE 401 that traverses 5G RAN 411. SMF 452 notifies AMF 451 that the PDU session is ready to begin. AMF 451 transfers a charging command to CHF 426 to meter slice usage for UE 401. AMF 451 transfers a session command to the RRC in CU 603 which forwards the command to RRC 503 over the PDCPs, RLCs, MACs, and PHYs. RRC 503 receives the command and directs the resource metering application to begin the PDU session. The resource metering application generates IoT data and the SDAP in UE 401 exchanges the IoT data for the PDU session with the SDAP in CU 603 based on the URSP rules over the PDCPs, RLCs, MACs, and PHYs. The SDAP in CU 603 exchanges the IoT data with UPF 453 in mMTC slice 450. UPF 453 exchanges the user data with data network 461 and reports usage data to CHF 426. In this example, UE 401 is not subscribed for service on mMTC slice 450. As such, CHF 426 generates an on-demand usage change for UE 401's service over mMTC slice 450 to enable service for UE 401 on mMTC slice 450. For example, CHF 426 may charge UE 401 based on the billing information included in the slice handover request.

The wireless data network circuitry described above comprises computer hardware and software that form special-purpose network circuitry to facilitate user-initiated slice handover. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to facilitate user-initiated slice handover.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
detecting a slice handover requirement;
selecting a network slice based at least on one or more session requirements in response to the slice handover requirement; and
wirelessly transferring a slice handover request that identifies the network slice to a wireless communication network wherein the wireless communication network performs a slice handover from a serving network slice to the network slice indicated in the slice handover request.

2. The method of claim 1 further comprising:
launching a user application; and
determining capabilities of a serving slice do not support one or more of an application type of the user application, a Quality-of-Service (QoS) requirement of the user application, or user preferences for the user application; and wherein:
detecting the slice handover requirement comprises:
detecting the slice handover requirement based on the capabilities of the serving slice not supporting the one or more of the application type of the user application, the QoS requirement of the user application, or the user preferences for the user application.

3. The method of claim 1 further comprising:
wirelessly receiving a slice information message from the wireless communication network that indicates available network slices, capabilities of the available network slices, network conditions for the available network slices, and operator policies for the available network slices; and wherein:
the network slice comprises one of the available network slices indicated by the slice information message;
selecting the network slice based at least on the session requirements comprises determining the capabilities, the network conditions, and the operator policies of the network slice support the session requirements; and
the session requirements comprise one or more of an application type of a user application, a Quality-of-Service (QoS) requirement of the user application, or user preferences for the user application.

4. The method of claim 3 wherein wirelessly receiving the slice information message from the wireless communication network comprises:
receiving a Session Information Block (SIB) message broadcast by a Radio Access Network (RAN) that includes the slice information message.

5. The method of claim 3 wherein wirelessly receiving the slice information message from the wireless communication network comprises:
wirelessly transferring an Application Programming Interface (API) call for delivery to a network slice catalog; and
wirelessly receiving an API response transferred by the network slice catalog and broadcast by a Radio Access Network (RAN) that includes the slice information message.

6. The method of claim 1 wherein selecting the network slice at least based on the session requirements comprises:
presenting a notification on a display of a user device that indicates the slice handover requirement and that requests user authorization to request a slice handover;
receiving a user input that authorizes the request for the slice handover; and
selecting the network slice based at least on the session requirements in response to the user input that authorizes the request for the slice handover.

7. The method of claim 1 wherein:
wirelessly transferring the slice handover request that identifies the network slice to the wireless communication network comprises wirelessly transferring the slice handover request that identifies the network slice and that includes billing information that directs the wireless communication network to charge for on-demand use of the network slice; and
the wireless communication network performs the slice handover from the serving network slice to the network slice indicated in the slice handover request and generates a charge for on-demand use of the network slice based on the billing information.

8. A user device comprising:
processing circuitry configured to:
detect a slice handover requirement; and
select a network slice based on session requirements in response to the slice handover requirement; and
radio circuitry configured to:
wirelessly transfer a slice handover request that identifies the network slice to a wireless communication network wherein the wireless communication network performs a slice handover from a serving network slice to the network slice indicated in the slice handover request.

9. The user device of claim 8 wherein the processing circuitry is further configured to:
launch a user application;
determine capabilities of a serving slice do not support one or more of an application type of the user application, a Quality-of-Service (QoS) requirement of the user application, or user preferences for the user application; and
detect the slice handover requirement based on the capabilities of the serving slice not supporting the one or more of the application type of the user application, the QoS requirement of the user application, or the user preferences for the user application.

10. The user device of claim 8 wherein the radio circuitry is further configured to:
wirelessly receive a slice information message from the wireless communication network that indicates available network slices, capabilities of the available network slices, network conditions for the available network slices, and operator policies for the available network slices;
and wherein the processing circuitry is further configured to:
determine the capabilities, the network conditions, and the operator policies of the network slice support the session requirements; and wherein:
the network slice comprises one of the available network slices indicated by the slice information message; and
the session requirements comprise one or more of an application type of a user application, a Quality-of-Service (QoS) requirement of the user application, or user preferences for the user application.

11. The user device of claim 10 wherein the radio circuitry is further configured to wirelessly receive a Session Information Block (SIB) message broadcast by a Radio Access Network (RAN) that includes the slice information message.

12. The user device of claim 10 wherein the radio circuitry is further configured to:
wirelessly transfer an Application Programming Interface (API) call for delivery to a network slice catalog; and
wirelessly receive an API response transferred by the network slice catalog and broadcast by a Radio Access Network (RAN) that includes the slice information message.

13. The user device of claim 8 wherein the processing circuitry is further configured to:
present a notification on a display of the user device that indicates the slice handover requirement and that requests user authorization to request a slice handover;
receive a user input that authorizes the request for the slice handover; and
select the network slice based on the session requirements in response to the user input that authorizes the request for the slice handover.

14. The user device of claim 8 wherein the radio circuitry is further configured to:
wirelessly transfer the slice handover request that identifies the network slice and that includes billing information that directs the wireless communication network to charge for on-demand use of the network slice; and wherein:
the wireless communication network performs the slice handover from the serving network slice to the network slice indicated in the slice handover request and generates a charge for on-demand use of the network slice based on the billing information.

15. One or more non-transitory computer readable storage media having program instructions stored thereon, wherein the program instruction, when executed by a computing system, direct the computing system to perform operations, the operations comprising:
in response to the launch of an application, detecting a slice handover requirement;
selecting a new network slice based at least on application requirements in response to the slice handover requirement; and
directing a radio to wirelessly transfer a slice handover request that identifies the new network slice to a wireless communication network wherein the wireless communication network performs a slice handover from a serving network slice to the new network slice indicated in the slice handover request.

16. The one or more computer readable storage media of claim 15 wherein detecting the slice handover requirement is performed in response to determining capabilities of a serving slice do not support one or more of an application type of the application, a Quality-of-Service (QoS) requirement of the application, or user preferences for the application, and wherein the detecting the slice handover requirement comprises:
detecting the slice handover requirement based on the capabilities of the serving slice not supporting the one or more of the application type of the application, the QoS requirement of the application, or the user preferences for the application.

17. The one or more computer readable storage media of claim 15 wherein the operations further comprise:
obtaining a slice information message wirelessly received over the radio from the wireless communication network that indicates available network slices, capabilities of the available network slices, network conditions for the available network slices, and operator policies for the available network slices; and wherein:
the new network slice comprises one of the available network slices indicated by the slice information message;
selecting the new network slice based at least on the application requirements comprises determining the capabilities, the network conditions, and the operator policies of the new network slice support the application requirements; and
the application requirements comprise one or more of an application type of a user application, a Quality-of-Service (QoS) requirement of the user application, or user preferences for the user application.

18. The one or more computer readable storage media of claim 17 wherein obtaining the slice information message wirelessly received over the radio from the wireless communication network comprises:
directing the radio to wirelessly transfer an Application Programming Interface (API) call for delivery to a network slice catalog; and
obtaining an API response transferred by the new network slice catalog and wirelessly received over the radio that includes the slice information message.

19. The one or more computer readable storage media of claim 15 wherein selecting the new network slice based at least on the application requirements comprises:
presenting a notification on a display of a user device that indicates the slice handover requirement and that requests user authorization to request a slice handover;
receiving a user input that authorizes the request for the slice handover; and
selecting the new network slice based at least on the session requirements in response to the user input that authorizes the request for the slice handover.

20. The one or more computer readable storage media of claim 15 wherein:
selecting the new network slice based at least on the application requirements comprises providing the application requirements to a data structure that correlates applications requirements to wireless network slices and selecting the new network slice based at least on the output from the data structure; and
the data structure comprises at least one of a rules-based system, a machine learning model, or/and optimization algorithm.
